(19) United States
(12) Patent Application Publication
(10) Pub. No.: US 2015/0017257 A1
(43) Pub. Date: Jan. 15, 2015

(54) Acidic Electrolyzed Water, Manufacturing Method Therefor, and Cleanser And Disinfectant Containing Acidic Electrolyzed Water

(71) Applicant: Molex Incorporated, Lisle, IL (US)

(72) Inventors: Megumi MURAMOTO, Yamato (JP); Kousuke TAKETOMI, Yamato (JP)

(73) Assignee: Molex Incorporated, Lisle, IL (US)

(21) Appl. No.: 14/327,822

(22) Filed: Jul. 10, 2014

(30) Foreign Application Priority Data
Jul. 10, 2013 (JP) 2013-144339

(51) Int. Cl. C02F 1/467; C11D 7/08; A01N 59/26; A01N 59/00; A01N 59/08; A01N 59/14

(52) U.S. Cl. CPC C02F 1/4674; A01N 59/08; A01N 59/14; A01N 59/26; A01N 59/00; C11D 7/08
USPC 424/605; 205/742; 424/680; 424/659; 424/600; 510/405

(57) ABSTRACT

To provide acidic electrolyzed water, a method for manufacturing acidic electrolyzed water, and a cleanser and a disinfectant containing acidic electrolyzed water which has disinfecting power for a long period of time, and which reduces the burden on living tissue. The acidic electrolyzed water has an effective chlorine concentration of 15 ppm or more, osmotic pressure from 235 mOsm to 435 mOsm, and a chlorine-based electrolyte content of 0.1 mass % or less in terms of sodium chloride.

### REFERENCE TO RELATED APPLICATIONS

The Present Disclosure claims priority to prior-filed Japanese Patent Application No. 2013-144339, entitled “Acidic Electrolyzed Water, Manufacturing Method Therefor, and Cleanser And Disinfectant Containing Acidic Electrolyzed Water,” and filed with the Japanese Patent Office on 10 Jul. 2013. The content of the aforementioned Application is fully incorporated herein in its entirety.

### BACKGROUND OF THE PRESENT DISCLOSURE

The Present Disclosure relates, generally, to acidic electrolyzed water, a method for manufacturing acidic electrolyzed water, as well as a cleanser and a disinfectant containing acidic electrolyzed water.

Acidic electrolyzed water is obtained by electrolyzing a solution of water and electrolytes such as sodium chloride and hydrochloric acid. Acidic electrolyzed water having a pH value of 2.7 or less is generally referred to as “strongly acidic water” and is known to have a strong disinfecting effect. An example of an acidic electrolyzed water is disclosed in U.S. Pat. No. 5,858,201, the content of which is hereby incorporated by reference in its entirety.

However, strongly acidic water maintains its disinfecting power for only a short period of time and cannot be stored for a very long period of time. Also, because the osmotic pressure of strongly acidic water is low, the difference in osmotic pressure can cause damage to cells when used, for example, to clean a wound.

### SUMMARY OF THE PRESENT DISCLOSURE

It is an object of the Present Disclosure to provide acidic electrolyzed water, a method for manufacturing acidic electrolyzed water, and a cleanser and a disinfectant containing acidic electrolyzed water which has disinfecting power for a long period of time, and which reduces the burden on living tissue.

The acidic electrolyzed water in an aspect of the Present Disclosure has an effective chlorine concentration of 15 ppm or more, osmotic pressure from 235 mOsm to 435 mOsm, and a chlorine-based electrolyte content of 0.1 mass % or less in terms of sodium chloride. In the Present Disclosure, “chorine-based electrolyte” referred to an electrolyte that generates chloride ions in an aqueous solution when dissolved in water.

The acidic electrolyzed water can have a pH value from 3.0 to 7.0. Further, the acidic electrolyzed water can contain an inorganic acid and/or inorganic acid salt. In the Present Disclosure, the inorganic acid can be boric acid, and the inorganic acid salt can be at least one type selected from among disodium dihydrogen pyrophosphate, sodium hexametaphosphate, and sodium dihydrogen phosphate. Finally, the acidic electrolyzed water can have an osmotic pressure of 285±50 mOsm.

The method for manufacturing acidic electrolyzed water in another aspect of the Present Disclosure includes the steps of adding an inorganic acid and/or inorganic acid salt to raw material acidic electrolyzed water with an effective chlorine concentration of 15 ppm or more, and adjusting the acidic electrolyzed water to an osmotic pressure from 235 mOsm to 435 mOsm, and a chlorine-based electrolyte content of 0.1 mass % or less in terms of sodium chloride. In the method for manufacturing acidic electrolyzed water, the inorganic acid can be boric acid, and the inorganic acid salt can be at least one type selected from among disodium dihydrogen pyrophosphate, sodium hexametaphosphate, and sodium dihydrogen phosphate. The method for manufacturing acidic electrolyzed water can also include a step of adjusting the raw material acidic electrolyzed water by electrolyzing a chlorine-based aqueous electrolyte solution. In the method for manufacturing acidic electrolyzed water, the adjusted acidic electrolyzed water can have an osmotic pressure of 285±50 mOsm.

Another aspect of the Present Disclosure is a cleanser containing the acidic electrolyzed water described above. Another aspect of the Present Disclosure is a disinfectant containing the acidic electrolyzed water described above.

Because the acidic electrolyzed water has an effective chlorine concentration of 15 ppm or more, osmotic pressure from 235 mOsm to 435 mOsm, and a chlorine-based electrolyte content of 0.1 mass % or less in terms of sodium chloride, it retains disinfecting power for a long period of time. As a result, it can be stored for a long period of time, reduces the burden on living tissue, and is very stable. It is easy to store because it retains its disinfecting power even when it is not stored in a dark place so long as it is not exposed to direct sunlight.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is the chemical equilibrium equation in the acidic electrolyzed water of the Present Disclosure; and

FIG. 2 is a graph showing the change over time in the effective chlorine concentration of the third example of the Present Disclosure in which the raw material is acidic electrolyzed water with a pH value of 2.23, the organic acid salts are disodium dihydrogen pyrophosphate, sodium hexametaphosphate and sodium dihydrogen phosphate, and the inorganic acid is boric acid.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

In the Present Disclosure, the term “parts” refers to “parts by mass,” unless otherwise indicated.

1. Acidic Electrolyzed Water

The acidic electrolyzed water in the present embodiment has an effective chlorine concentration of 15 ppm or more, and osmotic pressure from 235 mOsm to 435 mOsm. The acidic electrolyzed water in the present embodiment also has a chlorine-based electrolyte content of 0.1 mass % or less in terms of sodium chloride.

1.1. Effective Chlorine Concentration

The acidic electrolyzed water in the present embodiment has an effective chlorine concentration of 15 ppm or more, and preferably of 20 ppm or more, in order to exhibit sufficient disinfecting power. In the Present Disclosure, the effective chlorine concentration of the acidic electrolyzed water can be measured using a commercially available chlorine concentration measuring device.

1.2. Osmotic Pressure

The acidic electrolyzed water in the present embodiment has osmotic pressure from 235 mOsm to 435 mOsm in order to reduce the burden on living tissue. When used on the human body, the osmotic pressure is preferably 285±50 mOsm, and more preferably 285±10 mOsm, in order to be more compatible with the osmotic pressure of human cells. In the Present Disclosure, the osmotic pressure of the acidic electrolyzed water can be measured using a commercially available osmometer.

1.3. pH Value

The pH value of the acidic electrolyzed water in the present embodiment is preferably 7.0 or less, and more preferably from 3.0 to 7.0, in order to inhibit the production of trihalomethanes. In the Present Disclosure, the pH value of the acidic electrolyzed water can be measured using a commercially available pH measuring device.

1.4. Inorganic Acids and/or Inorganic Acid Salts

The acidic electrolyzed water in the present embodiment can contain an inorganic acid and/or inorganic acid salt. The osmotic pressure of acidic electrolyzed water in the present embodiment can be adjusted to the range mentioned above when the acidic electrolyzed water in the present embodiment contains an inorganic acid and/or inorganic acid salt.

The inorganic acid and/or inorganic acid salt preferably has an LD50 value greater than 300 mg/kg in order to lower the toxicity. An inorganic acid and/or inorganic acid salt with such an LD50 value is preferred from the standpoint of toxicity, especially when the acidic electrolyzed water in the present embodiment is used in pharmaceuticals, food products, and cosmetics.

The inorganic acid is preferably boric acid from the standpoint of stability. The inorganic acid salt may be a sodium salt, potassium salt, magnesium salt or barium salt, but a sodium salt is preferred from the standpoint of stability. More specifically, from the standpoint of even greater stability, the inorganic acid salt is at least one salt selected from among disodium dihydrogen pyrophosphate, sodium hexametaphosphate, and sodium dihydrogen phosphate.

In the acidic electrolyzed water of the present embodiment, one or more types of inorganic acid and/or inorganic acid salt may be used. The amount of inorganic acid and/or inorganic acid salt in the acidic electrolyzed water of the present embodiment depends on the osmotic pressure of the acidic electrolyzed water of the present embodiment. More specifically, an inorganic acid and/or inorganic acid salt is preferably added to adjust the osmotic pressure of the acidic electrolyzed water in the present embodiment to 285±50 mOsm.

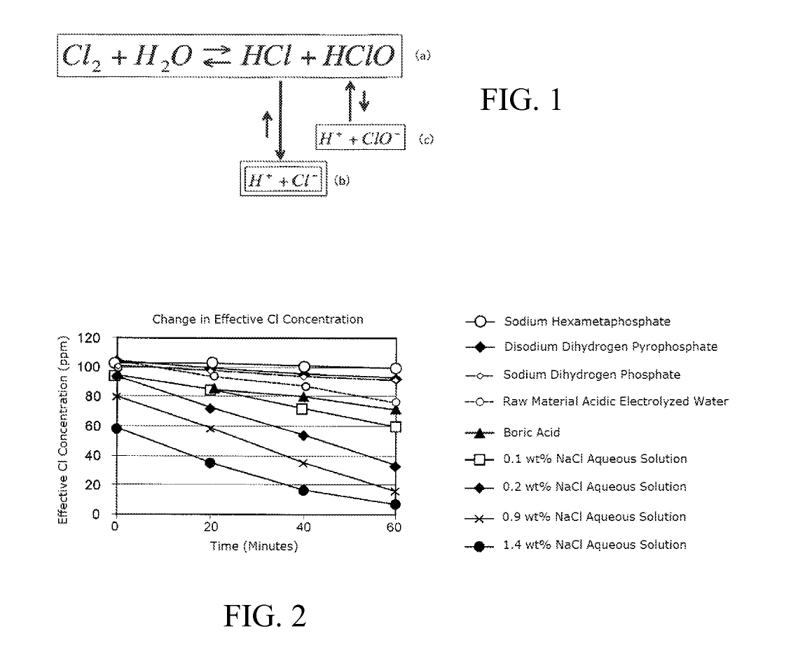

FIG. 1 is the chemical equilibrium equation in the acidic electrolyzed water of the Present Disclosure. Equation A in FIG. 1 maintains the equilibrium in the acidic electrolyzed water of the Present Disclosure. Hydrochloric acid maintains the equilibrium in the directions of Arrows 1 and 2 between Equation A in FIG. 1, and Equation B in FIG. 1, and hypochlorous acid maintains the equilibrium in the directions of Arrows 3 and 4 between Equation A in FIG. 1 and Equation C in FIG. 1. Because hydrochloric acid is a very strong acid, it is easy to ionize, and Arrow 2 predominates. Because hypochlorous acid is affected by hydrogen chloride, it is hardly ionized at all and Arrow 3 predominates.

For example, in order to adjust the osmotic pressure of acidic electrolyzed water of the Present Disclosure with an effective chlorine concentration of 50 ppm to 285±50 mOsm, the boric acid content is preferably from 14 to 20.2 g/L when the inorganic acid is boric acid, the content is preferably from 15.7 to 22.6 g/L when the inorganic acid salt is sodium dihydrogen phosphate, the content is preferably from 20.8 to 31.0 g/L when the inorganic acid salt is disodium dihydrogen pyrophosphate, and the content is preferably from 60.5 to 95.5 g/L when the inorganic acid salt is sodium hexametaphosphate. In order to more easily adjust the pH of the acidic electrolyzed water of the present embodiment to the desired value (for example, a pH value from 3.0 to 7.0), the inorganic acid and inorganic acid salt are preferably weakly acidic (for example, a pH value from 3.0 to 7.0). In the Present Disclosure, weakly acidic means the aqueous solution has a pH value from 3.0 to 7.0 when the inorganic acid or inorganic acid salt has been dissolved in water.

A weakly inorganic acid or weakly inorganic acid salt has a pH value from 3.0 to 7.0 when dissolved in water. As a result, the pH value of the acidic electrolyzed water is easy to control by including a weakly inorganic acid or weakly inorganic acid salt when the acidic electrolyzed water is prepared. Boric acid is an example of a weak inorganic acid, and disodium dihydrogen pyrophosphate and sodium hexametaphosphate are examples of weak inorganic acid salts.

The inorganic acid and/or inorganic acid salt is preferably not a chloride in order to prevent a reduction in the effective chlorine concentration. When the inorganic acid and/or inorganic acid salt is a chloride, the chloride ion concentration in the acidic electrolyzed water is increased. As a result, the equilibrium in Equation A of FIG. 1 is biased to the left, chlorine in the acidic electrolyzed water evaporates as a gas, and the effective chlorine concentration in the acidic electrolyzed water is reduced.

When the acidic electrolyzed water in the present embodiment is used in a toothpaste, dental cleanser or oral rinse, the inorganic acid salt is preferably disodium dihydrogen pyrophosphate because it prevents plaque buildup. When the amount of disodium dihydrogen pyrophosphate in the acidic electrolyzed water in the present embodiment is from 20.8 to 31.0 g/L for an effective chlorine concentration of 50 ppm, the disinfecting power lasts longer (at least up to three weeks and even six months or more), and plaque buildup can be prevented. The acidic electrolyzed water of the Present Disclosure may include components other than inorganic acids and/or inorganic acid salts as long as these components do not adversely affect the properties of the acidic electrolyzed water.

When the acidic electrolyzed water in the present embodiment is used in pharmaceuticals, food products and cosmetics, the inorganic acid salt is preferably sodium hexametaphosphate because of its moisturizing effect. When the acidic electrolyzed water in the present embodiment is used in pharmaceuticals (such as eye washes and eye medications) and cosmetics (such as bath salts), the inorganic acid is preferably boric acid because of its disinfecting properties.

1.5. Chlorine-Based Electrolyte Content

The chlorine-based electrolyte content of the acidic electrolyzed water in the present embodiment is preferably 0.1 mass % or less in terms of sodium chloride in order to prevent corrosion of metal and the escape of chlorine gas from the acidic electrolyzed water in the present embodiment. The chlorine-based electrolyte content is more preferably 0.05 mass % or less in terms of sodium chloride. When the (added) chlorine-based electrolyte content of the acidic electrolyzed water in the present embodiment exceeds 0.1 mass % in terms of sodium chloride, the chloride ions bond with the hydrogen ions in the acidic electrolyzed water. As a result, the equilibrium between Equation A and Equation B in FIG. 1 is biased in the direction of Arrow 1, and the equilibrium of Equation A in FIG. 1 is biased to the left. Consequently, the chloride ions are released as chlorine, the effective chlorine concentration of the acidic electrolyzed water is lowered, and the disinfecting effect is reduced.

More preferably, the acidic electrolyzed water in the present embodiment is substantially free of chlorine-based electrolytes. In the Present Disclosure, substantially free of chlorine-based electrolytes means the concentration of chlorine-based electrolytes in the acidic electrolyzed water in the present embodiment is 0.025 mass %. In other words, it means chlorine-based electrolytes have not been added to the acidic electrolyzed water in the present embodiment.

In the Present Disclosure, “chlorine-based electrolyte” refers to an electrolyte that produces chloride ions when dissolved in water. Chlorine-based electrolytes include chlorides of alkali metals (such as sodium chloride and potassium chloride), and chlorides of alkaline rare earth metals (such as calcium chloride and magnesium chloride). More specifically, the (added) sodium chloride content of the acidic electrolyzed water in the present embodiment is preferably less than 0.1 mass % in terms of sodium chloride, and preferably less than 0.05 mass % in terms of sodium chloride.

1.6. Operational Effects

Because the acidic electrolyzed water has an effective chlorine concentration of 15 ppm or more, osmotic pressure from 235 mOsm to 435 mOsm, and a chlorine-based electrolyte content of 0.1 mass % or less in terms of sodium chloride, it retains disinfecting power for a long period of time. As a result, it can be stored for a long period of time, reduces the burden on living tissue, and is very stable. It is easy to store because it retains its disinfecting power even when it is not stored in a dark place so long as it is not exposed to direct sunlight.

When organics such as organic acids and organic acid salts are present in acidic electrolyzed water, the organics are usually oxidized by chlorine and consume the chlorine. As a result, the disinfecting power is reduced. However, by using inorganic acid salts instead of these organics, they are not oxidized by the chlorine, and the disinfecting power can be maintained for an extended period of time. When the acidic electrolyzed water of the present embodiment is substantially free of organics, the oxidizing power can be maintained for an especially long period of time.

2. Acidic Electrolyzed Water Manufacturing Method

The method for manufacturing acidic electrolyzed water in the embodiment of the Present Disclosure includes a step of adding an inorganic acid and/or inorganic acid salt to raw material acidic electrolyzed water with an effective chlorine concentration of 15 ppm or more, and adjusting the acidic electrolyzed water to an osmotic pressure from 235 mOsm to 435 mOsm, and a chlorine-based electrolyte content of 0.1 mass % or less in terms of sodium chloride. The raw material acidic electrolyzed water used in the method for manufacturing acidic electrolyzed water in the present embodiment (referred to herein simply as the “raw material acidic electrolyzed water”) has an effective chlorine concentration of 15 ppm or more (and preferably 20 ppm or more).

2.1. Preparation of Raw Material Acidic Electrolyzed Water

The method for manufacturing acidic electrolyzed water according to the present embodiment can include the step of adjusting the raw material acidic electrolyzed water by electrolyzing a chlorine-based aqueous electrolyte solution. The sodium ion concentration in the raw material acidic electrolyzed water can be 1 ppm or less.

The raw material acidic electrolyzed water can be prepared by adding a chlorine-based electrolyte aqueous solution to the anode chamber and the cathode of a water electrolyzing device (two-tank water electrolyzing device) and performing electrolysis on the aqueous solution. The chambers in this water electrolyzing device are separated by a barrier membrane. The raw material acidic electrolyzed water can also be prepared by adding a high-concentration chlorine-based electrolyte aqueous solution to the central chamber of a three-tank water electrolyzing device and performing electrolysis on the aqueous solution. The cathode chamber, central chamber and anode chamber in this water electrolyzing device are separated by a pair of barrier membranes.

When the electrolysis is performed using a two-tank water electrolyzing device, the concentration of the chlorine-based electrolyzed aqueous solution is preferably from 0.1 to 0.2%. When the electrolysis is performed using a three-tank water electrolyzing device, the concentration of the high-concentration chlorine-based electrolyzed aqueous solution is preferably as high as possible without adversely affecting the properties of the raw material acidic electrolyzed water.

The raw material acidic electrolyzed water is preferably prepared using a three-tank water electrolyzing device from the standpoint of a low concentration of electrolytes in the resulting raw material acidic electrolyzed water. When the raw material acidic electrolyzed water is prepared using a two-tank water electrolyzing device the concentration of electrolytes in the resulting raw material acidic electrolyzed water may be reduced by adding purified water (such as distilled water or ion-exchange water) to the electrolyzed water produced by the two-tank water electrolyzing device.

The water electrolyzing device used to prepare the raw material acid electrolyzed water may be constructed from scratch. However, the raw material acidic electrolyzed water may be prepared using a commercially available water electrolyzing device as models of the water electrolyzing devices described above are available commercially.

Examples of commercially available water electrolyzing devices include the Excel-FX (MX-99) from Nambu Co., Ltd.; the ROX-10WB3 from Hoshizaki Denki Co., Ltd.; the a-Light from Amano Co., Ltd.; the ESS-Zero from Shinsei Co., Ltd.; and the desktop Fineoxer FO-1000S2 from First Ocean Co., Ltd. The raw material acidic electrolyzed water can be manufactured using any commercially available electrolyzed water manufacturing device. The raw material acidic electrolyzed water can also be manufactured using the electrolyzed water manufacturing method described in Japanese Patent Application No. 2000-108971, the content of which is hereby incorporated herein in its entirety.

2.2. Addition of Inorganic Acids and/or Inorganic Acid Salts to Raw Material Acidic Electrolyzed Water

The amount of inorganic acid and/or inorganic acid salt added to the raw material acidic electrolyzed water when the acidic electrolyzed water in the present embodiment is manufactured is described above in Section 1.4 (Inorganic Acids and/or Inorganic Acid Salts). The pH value of the raw material acidic electrolyzed water used when the acidic electrolyzed water in the present embodiment is manufactured is preferably from 1.7 to 7.0, more preferably from 1.7 to 6.0, and even more preferably from 1.8 to 6.0.

3. Applications

The acidic electrolyzed water in the present embodiment can be used as a disinfectant and/or cleanser in various fields such as medicine, veterinary medicine, food processing, and manufacturing. It can be used to clean and disinfect tools and affected areas in medicine and veterinary medicine. The acidic electrolyzed water in the present embodiment is not unpleasant to use because it lacks a pungent odor such as the odor of halogens.

Because the acidic electrolyzed water in the present embodiment is adjusted to an osmotic pressure between 235 mOsm and 435 mOsm, it has an osmotic pressure similar to that of cells and thus reduces the burden on living tissue. For example, when the acidic electrolyzed water in the present embodiment is used as a cleaning solution on an affected area (wound or suture marks), any pain caused by a difference in osmotic pressure can be reduced by adjusting the osmotic pressure of the acidic electrolyzed water in the present embodiment to the range mentioned above. Therefore, the acidic electrolyzed water in the present embodiment can be used as a disinfectant and/or cleanser in medicine and veterinary medicine.

The acidic electrolyzed water in the present embodiment can also be used as an oral cleanser (toothpaste, mouthwash, dental paste). Because the osmotic pressure of the acidic electrolyzed water in the present embodiment is adjusted to the range mentioned above when used as an oral cleanser, irritation of the oral cavity is reduced, and there is no penetrating sensation.

When the acidic electrolyzed water in the present embodiment contains disodium dihydrogen pyrophosphate, the acidic electrolyzed water in the present embodiment is especially ideal for use in dental cleansers as it helps prevent plaque buildup. When the acidic electrolyzed water in the present embodiment contains sodium hexametaphosphate, it is especially ideal for use in a cosmetic lotion, disinfecting spray, disinfecting liquid or hand disinfectant as it has a moisturizing effect. When the acidic electrolyzed water in the present embodiment contains boric acid, it is especially ideal for use in eye washes, eye medicines and bath salts as it has a disinfecting effect. Because the acidic electrolyzed water in the present embodiment is very stable, it can be placed in a container and used as acidic electrolyzed water inside the container.

4. Examples

The following is a more detailed explanation of the Present Disclosure with reference to examples. The Present Disclosure is not limited to these examples.

4.1. Example 1 (Preparation of Raw Material Acidic Electrolyzed Water)

First, the raw material acidic electrolyzed water was prepared for used in the example. Raw material acidic electrolyzed water 1 and 2 were manufactured using a desktop Fineoxer FO-1000S2 electrolyzed water manufacturing device from First Ocean Co., Ltd. When the raw material acidic electrolyzed water was prepared, sodium chloride was used as the chlorine-based electrolyte. The resulting raw material acidic electrolyzed water had an effective chlorine concentration of 105 ppm, a pH value of 2.23, and a sodium ion concentration of 1 ppm.

In this example, the pH value was measured using a pH measuring device (Handy Digital pH Meter SK-620 PH from Sato Keiryoki Mfg. Co., Ltd.), and the effective chlorine concentration was measured using a chlorine concentration measuring device (Aquab from Shibata Kagaku Co., Ltd.).

4.2 Example 2 (Preparation of Acidic Electrolyzed Water)

Next, 24 g of disodium dihydrogen pyrophosphate (Taihei Chemical Industrial Co., Ltd.) was dissolved in 1,000 mL of raw material acidic electrolyzed water to produce acidic electrolyzed water containing disodium dihydrogen pyrophosphate (osmotic pressure: 282 mOsm, pH value: 3.23). Also, 70 g of sodium hexametaphosphate (Happo Shokai Co., Ltd.) was dissolved in 1,000 mL of raw material acidic electrolyzed water to produce acidic electrolyzed water containing sodium hexametaphosphate (osmotic pressure: 272 mOsm, pH value: 5.82). Also, 19 g of sodium dihydrogen phosphate (Happo Shokai Co., Ltd.) was dissolved in 1,000 mL of raw material acidic electrolyzed water to produce acidic electrolyzed water containing sodium dihydrogen phosphate (osmotic pressure: 284 mOsm, pH value: 3.45). Also, 17 g of boric acid (Wako Fine Chemicals, Ltd.) was dissolved in 1,000 mL of raw material acidic electrolyzed water to produce acidic electrolyzed water containing boric acid (osmotic pressure: 290 mOsm, pH value: 2.23).

4.3. Example 3 (Measurement of Effective Chlorine Concentration)

The effective chlorine concentration of each type of acidic electrolyzed water obtained in Example 2 was measured. As controls, 0.1 mass %, 0.2 mass %, 0.9 mass % and 1.4 mass % sodium chloride was added to the raw material acidic electrolyzed water, and stored at room temperature (23° C.). The change over time in the effective chlorine concentration is shown in FIG. 2.

FIG. 2 is a graph showing the change over time in the effective chlorine concentration of strongly acidic water obtained by adding the inorganic salts disodium dihydrogen pyrophosphate, sodium hexametaphosphate, and sodium dihydrogen phosphate to raw material acidic electrolyzed water with a pH value of 2.23, and the change over time in the effective chlorine concentration of strongly acidic water obtained by adding boric acid as the inorganic acid to the same raw material acidic electrolyzed water. As shown in FIG. 2, 60 minutes after the adjustment, the effective chlorine concentrations of the sodium chloride aqueous solutions with sodium chloride concentrations of 0.2 mass %, 0.9 mass % and 1.4 mass % had declined significantly.

In contrast, the effective chlorine concentrations of the acidic electrolyzed water containing the inorganic salts (disodium dihydrogen pyrophosphate, sodium hexametaphosphate, and sodium dihydrogen phosphate) and the acidic electrolyzed water containing the inorganic acid (boric acid) had changed very little 60 minutes after adjustment. Among these, the effective chlorine concentrations of the acidic electrolyzed water containing the inorganic salts (disodium dihydrogen pyrophosphate, sodium hexametaphosphate, and sodium dihydrogen phosphate) had changed hardly at all.

While a preferred embodiment of the Present Disclosure is shown and described, it is envisioned that those skilled in the art may devise various modifications without departing from the spirit and scope of the foregoing Description and the appended Claims.

What is claimed is:

1. Acidic electrolyzed water having an effective chlorine concentration of 15 ppm or more, osmotic pressure from 235 mOsm to 435 mOsm, and a chlorine-based electrolyte content of 0.1 mass % or less in terms of sodium chloride.

2. The acidic electrolyzed water of claim 1, wherein the osmotic pressure is 285±mOsm.

3. The acidic electrolyzed water of claim 1, wherein the pH value is from 3.0 to 7.0.

4. The acidic electrolyzed water of claim 3, wherein the osmotic pressure is 285±mOsm.

5. The acidic electrolyzed water of claim 3, further comprising an inorganic acid and/or inorganic acid salt.

6. The acidic electrolyzed water of claim 5, wherein the inorganic acid is boric acid, and the inorganic acid salt is at least one type selected from among disodium dihydrogen pyrophosphate, sodium hexametaphosphate, and sodium dihydrogen phosphate.

7. The acidic electrolyzed water of claim 6, wherein the osmotic pressure is 285±mOsm.

8. The acidic electrolyzed water of claim 1, further comprising an inorganic acid and/or inorganic acid salt.

9. The acidic electrolyzed water of claim 8, wherein the inorganic acid is boric acid, and the inorganic acid salt is at least one type selected from among disodium dihydrogen pyrophosphate, sodium hexametaphosphate, and sodium dihydrogen phosphate.

10. The acidic electrolyzed water of claim 9, wherein the osmotic pressure is 285±mOsm.

11. A cleanser containing the acidic electrolyzed water of claim 1.

12. A disinfectant containing the acidic electrolyzed water of claim 1.

13. A method for manufacturing acidic electrolyzed water, comprising the steps of:
adding an inorganic acid and/or inorganic acid salt to raw material acidic electrolyzed water with an effective chlorine concentration of 15 ppm or more; and
adjusting the acidic electrolyzed water to an osmotic pressure from 235 mOsm to 435 mOsm, and a chlorine-based electrolyte content of 0.1 mass % or less in terms of sodium chloride.

14. The method of claim 13, wherein the adjusted acidic electrolyzed water has an osmotic pressure of 285±50 mOsm.

15. The method of claim 13, further comprising the step of adjusting the raw material acidic electrolyzed water by electrolyzing a chlorine-based aqueous electrolyte solution.

16. The method of claim 15, wherein the adjusted acidic electrolyzed water has an osmotic pressure of 285±50 mOsm.

17. The method of claim 13, wherein the inorganic acid is boric acid, and the inorganic acid salt is at least one type selected from among disodium dihydrogen pyrophosphate, sodium hexametaphosphate, and sodium dihydrogen phosphate.

18. The method of claim 17, wherein the adjusted acidic electrolyzed water has an osmotic pressure of 285±50 mOsm.

19. The method of claim 17, further comprising the step of adjusting the raw material acidic electrolyzed water by electrolyzing a chlorine-based aqueous electrolyte solution.

20. The method of claim 19, wherein the adjusted acidic electrolyzed water has an osmotic pressure of 285±50 mOsm.
